(19) United States
(12) Patent Application Publication
(10) Pub. No.: US 2026/0330312 A1
(43) Pub. Date: Oct. 22, 2026

(54) SYSTEMS AND METHODS FOR HUMAN INTERACTION PROFILES AND INFERENCE-TIME CONTROL OF ARTIFICIAL INTELLIGENCE SYSTEMS

(71) Applicant: Resources Hub LLC, San Jose, CA (US)

(72) Inventor: Maen Alhorani, San Jose, CA (US)

(21) Appl. No.: 19/559,756

(22) Filed: Mar. 6, 2026

Related U.S. Application Data
(60) Provisional application No. 63/791,427, filed on Apr. 19, 2025.
(60) Provisional application No. 63/959,688, filed on Jan. 13, 2026.

(51) Int. Cl. G06N 20/00; H04L 67/306

(52) U.S. Cl. CPC G06N 20/00; H04L 67/306

(57) ABSTRACT

A computer-implemented system and method for controlling artificial intelligence interactions using portable human interaction profiles and an inference control gateway. The system generates a structured interaction profile representing communication preferences, behavioral characteristics, and contextual interaction attributes associated with a user. The interaction profile is stored as a portable artifact and injected dynamically into artificial intelligence inference requests. An inference gateway positioned between applications and artificial intelligence providers applies behavioral policies and evaluation metrics to model outputs before returning responses. The system enables consistent personalization, policy enforcement, and cross-provider evaluation of artificial intelligence systems while maintaining stateless execution of models.

### CROSS-REFERENCE TO RELATED APPLICATIONS

This application claims priority to:
U.S. Provisional Patent Application No. 63/791,427, filed Apr. 19, 2025.
U.S. Provisional Patent Application No. 63/959,688, filed Jan. 13, 2026.

Both applications are incorporated herein by reference in their entirety.

### FIELD OF THE INVENTION

The present invention relates to artificial intelligence systems and, more particularly, to systems and methods for controlling artificial intelligence inference behavior using portable interaction profiles and an inference control gateway.

### BACKGROUND

Artificial intelligence systems are commonly accessed through application programming interfaces exposed by external providers. Applications typically send prompts directly to provider endpoints and return responses without intermediate enforcement or personalization layers.

Existing personalization approaches rely on prompt engineering, application memory, or model fine-tuning.

These approaches present several limitations. Personalization is not portable across systems. Models cannot consistently adapt to user interaction preferences. Safety enforcement often occurs outside the inference pipeline. Cross-provider evaluation is difficult to perform.

There is therefore a need for a system capable of representing human interaction characteristics in a portable artifact, enforcing behavioral rules during artificial intelligence inference, and evaluating model outputs before returning responses.

### SUMMARY OF THE INVENTION

The present invention provides a system for controlling artificial intelligence behavior using human interaction profiles and an inference control gateway.

The system includes:
a human interaction profile generator
an inference gateway positioned between applications and artificial intelligence providers
a policy enforcement engine
an evaluation module
a response controller

A human interaction profile is generated representing communication and behavioral characteristics associated with a user.

The profile is injected into inference requests sent to artificial intelligence providers.

The inference gateway applies behavioral rules and evaluation metrics to responses generated by artificial intelligence models.

Responses may be accepted, modified, or rejected before being returned to the application.

The system enables consistent personalization and policy enforcement across multiple artificial intelligence providers.

In certain embodiments, the system functions as an artificial intelligence inference control plane positioned between applications and external artificial intelligence providers. The inference control plane may enforce behavioral policies, inject contextual interaction artifacts, evaluate responses generated by artificial intelligence models, and determine whether responses satisfy predefined behavioral or structural requirements before returning responses to client applications. This architecture enables consistent enforcement of interaction rules and evaluation metrics across multiple artificial intelligence providers while maintaining stateless operation of underlying models.

### BRIEF DESCRIPTION OF THE DRAWINGS

FIG. 1 illustrates a system architecture for generating human interaction profiles and controlling artificial intelligence inference behavior.

FIG. 2 illustrates a process for generating a human interaction profile from behavioral inputs.

FIG. 3 illustrates an inference gateway architecture positioned between applications and artificial intelligence providers.

FIG. 4 illustrates a context assembly process combining prompts, interaction profiles, and contextual inputs.

FIG. 5 illustrates policy enforcement and response validation performed by the inference gateway.

FIG. 6 illustrates cross-provider inference routing and response comparison.

FIG. 7 illustrates an evaluation pipeline for detecting hallucination signals, schema violations, and behavioral rule violations.

FIG. 8 illustrates a feedback loop for refining interaction profiles using observed interaction outcomes.

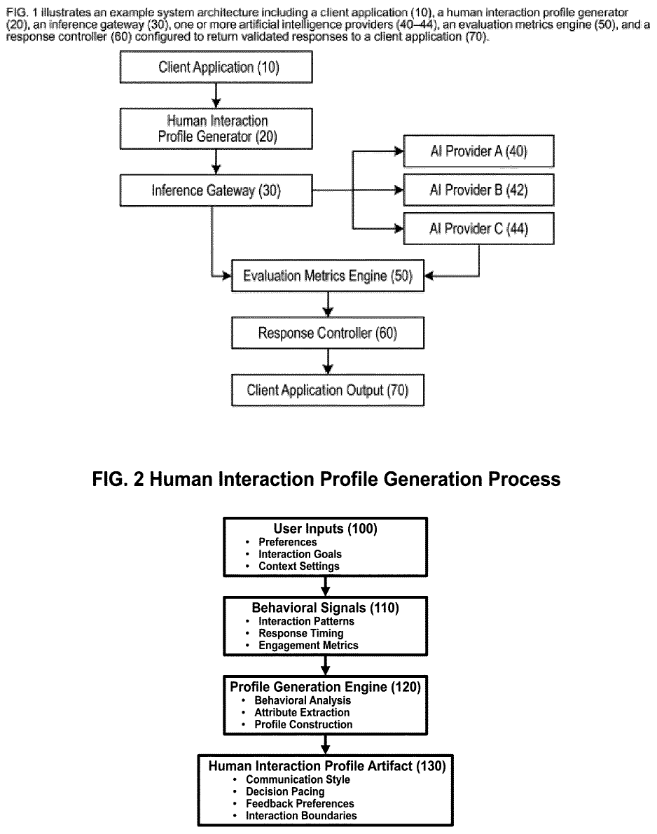

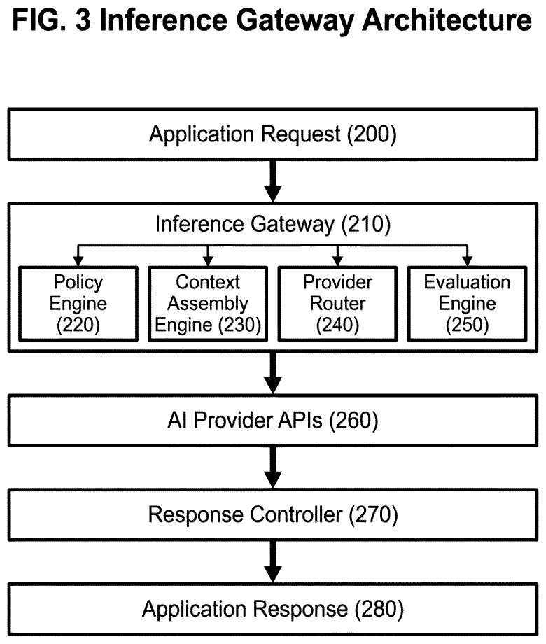

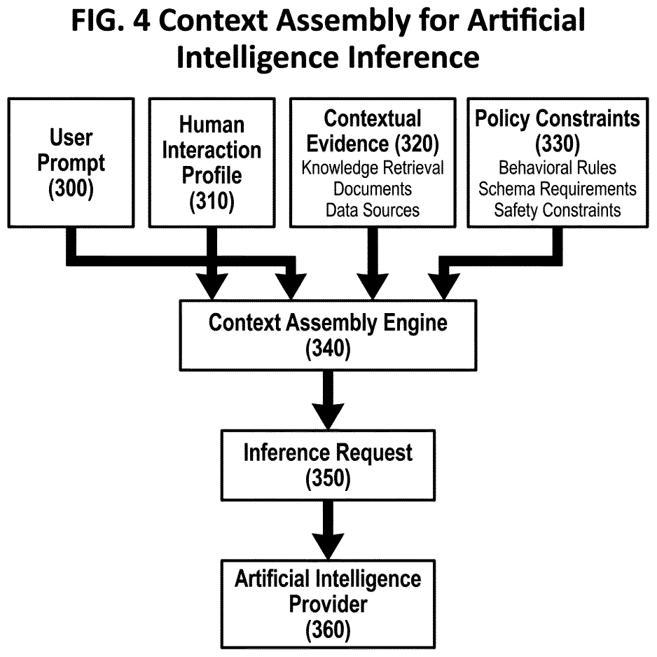

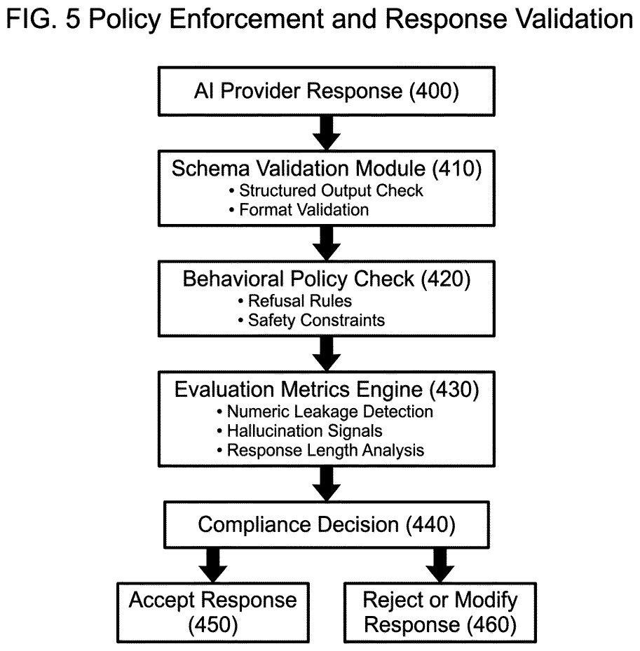

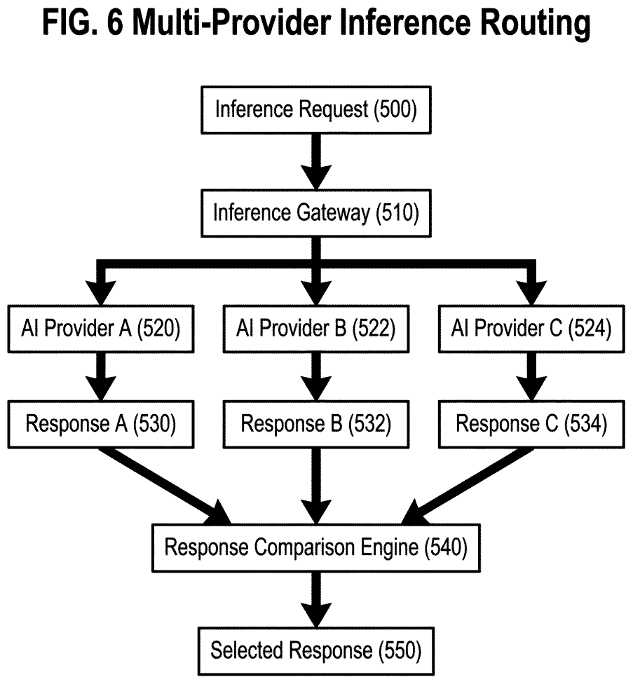

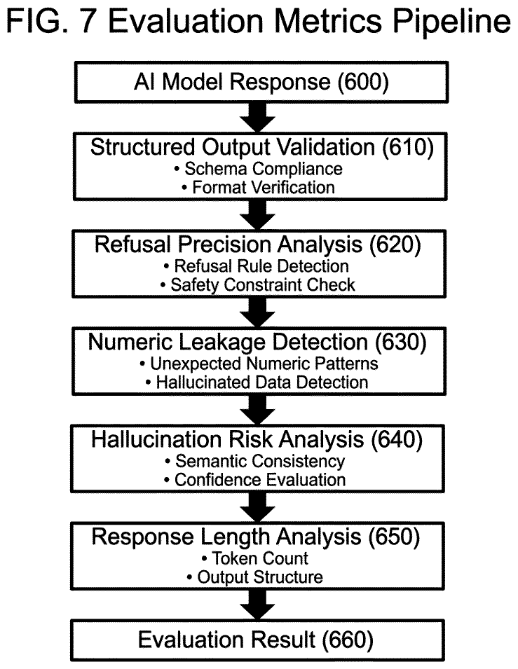

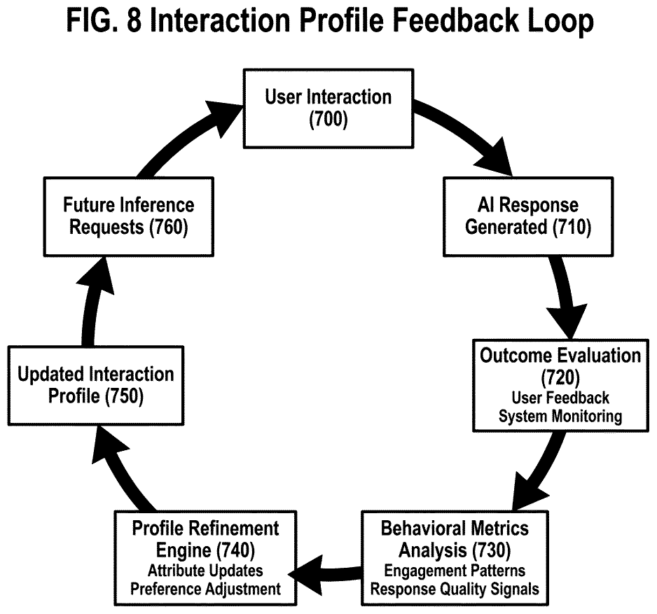

### DETAILED DESCRIPTION OF THE INVENTION

### System Architecture

The system comprises several modules that operate together to control artificial intelligence inference behavior.

### 1. Human Interaction Profile Generator

The human interaction profile generator creates a structured profile describing user interaction characteristics.

Example attributes may include:
communication style
decision pacing
feedback format preferences
interaction boundaries
contextual interaction modes

The generated profile is stored as a portable artifact.

### 2. Interaction Artifact Storage

The interaction profile is represented as structured machine-readable data.

Example formats include:
JSON
structured objects
standardized metadata formats

The artifact may be transmitted between systems or applications.

### 3. Inference Gateway

The inference gateway sits between applications and artificial intelligence providers.

Responsibilities include:
receiving inference requests
injecting contextual artifacts
routing requests to artificial intelligence providers
validating responses

The gateway acts as an intermediate control layer between client applications and artificial intelligence model services.

### 4. Policy Enforcement Engine

The policy engine applies behavioral rules to inference requests and responses.

Examples include:
refusal rules
response format constraints
schema validation
grounding requirements

These rules ensure responses comply with predefined behavioral policies.

### 5. Evaluation Metrics Engine

The gateway evaluates responses returned by artificial intelligence providers.

Example metrics include:
structured output validation
refusal precision checks
hallucination risk detection
numeric leakage detection
response length analysis

Evaluation occurs inline during inference execution before responses are returned to the requesting application.

### 6. Response Controller

The response controller determines whether responses satisfy enforcement criteria.

Possible actions include:
returning the response
modifying the response
rejecting the response
selecting an alternative response

The controller may also request regeneration of a response from the artificial intelligence provider.

### Interaction Profile Attributes

The human interaction profile may contain structured attributes describing interaction characteristics associated with a user.

Example attributes include:
communication tone preferences
decision pacing characteristics
preferred response length
feedback sensitivity indicators
cognitive load tolerance
interaction boundaries and consent flags
contextual interaction modes

Attributes may be derived from explicit user configuration, behavioral observation, machine-learning models, or external contextual inputs.

### Interaction Profile Driven Inference Control

In certain embodiments the human interaction profile may be supplied to an inference gateway that controls requests transmitted to artificial intelligence providers.

The gateway may assemble inference requests by combining prompts, interaction profiles, contextual evidence, and policy constraints.

By incorporating the interaction profile during inference execution, artificial intelligence systems may generate responses aligned with user interaction characteristics without requiring persistent storage of user data.

### Context Assembly Process

The inference gateway may construct inference requests by combining:
a user prompt
a human interaction profile artifact
contextual evidence retrieved from a knowledge repository
policy constraints

The resulting request may be transmitted to one or more artificial intelligence providers.

### Cross-Provider Inference

In certain embodiments the inference gateway may route inference requests to multiple artificial intelligence providers.

Responses generated by the providers may be evaluated using behavioral metrics.

The gateway may select or synthesize responses based on evaluation results.

### Inline Behavioral Evaluation

The inference gateway may evaluate model responses using deterministic metrics including:
refusal precision metrics
structured output verification
numeric leakage detection
hallucination risk signals
response length analysis
policy compliance checks

Evaluation occurs before responses are returned to the client application.

### Response Control Actions

Based on evaluation results the gateway may:
return the response unchanged
modify the response
reject the response
request regeneration from the provider
select a response from multiple providers

### Example Execution Flow

Client application submits an inference request.

An interaction profile is attached to the request.

The gateway injects policy constraints.

The request is transmitted to an artificial intelligence provider.

The provider returns a response.

The gateway performs evaluation and enforcement.

The response is returned to the client application.

### Alternative Embodiments

The systems and methods described herein may be implemented in a variety of computing environments and architectural configurations.

In certain embodiments the inference gateway may be implemented as a cloud-based service accessible through application programming interfaces. In other embodiments the gateway may be deployed within on-premise enterprise environments or integrated directly into application infrastructure.

Human interaction profiles may be represented using different data structures including structured documents, serialized objects, encrypted tokens, or standardized metadata representations.

Evaluation modules may incorporate additional behavioral or performance metrics beyond those explicitly described, including statistical response analysis, semantic similarity evaluation, or probabilistic confidence scoring.

Various modifications and alternative configurations may be employed without departing from the scope of the invention.

1. A computer-implemented method for controlling artificial intelligence interaction behavior comprising:
receiving inputs associated with a user;
generating a human interaction profile representing behavioral characteristics associated with the user;
storing the human interaction profile as a portable interaction artifact;
injecting the artifact into an artificial intelligence inference request;
executing the inference request using an artificial intelligence system; and
generating responses conditioned on attributes contained within the artifact.

2. A system for controlling artificial intelligence inference comprising:
an inference gateway positioned between an application and one or more artificial intelligence providers;
a policy engine configured to apply behavioral rules to inference requests;
an evaluation module configured to analyze responses generated by the artificial intelligence providers; and
a response controller configured to return responses to the application based on evaluation results.

3. A computer-implemented system comprising:
an inference gateway configured to receive inference requests from an application;
a context assembly engine configured to attach a human interaction profile to the inference request;
a routing module configured to transmit the request to one or more artificial intelligence providers; and
an evaluation module configured to analyze responses returned by the providers and determine whether the responses satisfy predefined behavioral rules.

4. A method for controlling artificial intelligence systems comprising:
transmitting an inference request to multiple artificial intelligence providers;
injecting a human interaction profile into each request;
evaluating responses generated by the providers using behavioral metrics; and
returning a response selected based on compliance with the behavioral metrics.

5. The method of claim 1 wherein the interaction profile includes communication style attributes.

6. The method of claim 1 wherein the interaction profile includes decision pacing attributes.

7. The method of claim 1 wherein the interaction profile includes feedback sensitivity indicators.

8. The method of claim 1 wherein the artificial intelligence system operates in a stateless execution mode.

9. The method of claim 1 further comprising retrieving contextual evidence from a knowledge repository.

10. The system of claim 2 wherein the evaluation module performs structured output validation.

11. The system of claim 2 wherein the evaluation module performs hallucination risk detection.

12. The system of claim 2 wherein the evaluation module performs numeric leakage detection.

13. The system of claim 2 wherein responses are rejected when behavioral rules are violated.

14. The method of claim 4 wherein responses from multiple providers are compared.

15. The method of claim 4 wherein a response is selected based on evaluation metrics.

16. The system of claim 2 wherein the inference gateway routes requests to multiple providers.

17. The system of claim 2 wherein the gateway modifies inference requests before transmission.

18. The system of claim 2 wherein the gateway injects contextual policies.

19. The method of claim 1 wherein the interaction artifact is transmitted between applications.

20. The system of claim 2 wherein evaluation metrics include response length analysis.

21. The system of claim 2 wherein the gateway enforces schema validation.

22. The system of claim 2 wherein the evaluation module performs refusal precision analysis.

23. The system of claim 2 wherein the gateway detects hallucinated numeric values.

24. The method of claim 1 wherein the interaction profile includes consent metadata controlling disclosure of attributes.

25. The system of claim 2 wherein the gateway selects responses from multiple providers based on compliance scores.

26. The method of claim 4 wherein responses from multiple providers are compared to detect behavioral drift.
